(19) United States
(12) Patent Application Publication
(10) Pub. No.: US 2013/0006794 A1
(43) Pub. Date: Jan. 3, 2013

(54) ONLINE MARKETPLACE WITH OFFER/BID POOLING

(75) Inventors: Eric Horvitz, Kirkland, WA (US); Stelios Paparizos, San Jose, CA (US); Roger Barga, Bellevue, WA (US); Zachary Apter, Seattle, WA (US); Vinay Gupta, Sammamish, WA (US); Xuedong Huang, Bellevue, WA (US); Gur Kimchi, Bellevue, WA (US); Marc Davis, San Francisco, CA (US)

(73) Assignee: MICROSOFT CORPORATION, Redmond, WA (US)

(21) Appl. No.: 13/174,268

(22) Filed: Jun. 30, 2011

(51) Int. Cl. G06Q 30/00

(52) U.S. Cl. 705/26.2

(57) ABSTRACT

Systems and methods for facilitating purchase transactions through real-time dynamic marketplace sessions are provided. A method may include pooling offers for goods/services to form a pooled offer, and pooling bids to form a pooled bid. The pooled offer and the pooled bid may be matched to form a pooled offer/bid pair. Methods for inducing and using predictive models for successful configuration of properties and participants with machine learning procedures that operate on data about successful and unsuccessful offers may be employed. A real-time dynamic marketplace session may be established between offer agents associated with the pooled offers and bid agents associated with the pooled bids. Upon a successful conclusion to the negotiation, a purchase transaction for the pooled offer/bid pair may be processed.

### BACKGROUND

On-line shopping services typically facilitate purchasing transactions that enable individual customers to purchase goods and/or services from a merchant. Some on-line services, such as travel reservation websites, may search among multiple merchants for products and/or services that match a user's search criteria. Deal-of-the-day and other group buying websites may offer products or services at discounted prices for a limited period of time to users who subscribe to these services. However, even when products and services are offered in bundles, or offered to a subscriber group as described above, many of these offers may be priced just beyond a potential buyer's willingness to pay. Sellers in current online marketplaces have no way to communicate with other sellers and with buyers, for example, to learn that a buyer may be willing to pay just a little less, or to learn that another seller may be willing to offer a product of particular value to a potential buyer. Further, buyers have no way to communicate with other potential buyers, to learn for example of buyers with like purchasing interests, which may be of use to obtain a bulk discount. As a result of these marketplace portal inefficiences, willing buyers and willing sellers may miss many opportunities to consummate sales that would be of mutual benefit.

### SUMMARY

Systems and methods for facilitating purchase transactions through real-time dynamic marketplace sessions are disclosed herein. One method may include receiving a plurality of offers for goods/services and gathering the offers in an offer pool. The method includes pooling at least two of the offers to form a pooled offer, and pooling at least two bids received from respective bid agents to form a pooled bid.

The method may also include matching the pooled offer to the pooled bid to form a pooled offer/bid pair. The method then includes establishing a real-time dynamic marketplace session between the offer agents associated with the offers and the bid agents associated with the bids. The method may include sending the pooled offer/bid pair to the offer agents, and receiving acceptances of the pooled offer/bid pair from the offer agents. The method then includes processing a purchase transaction for the pooled offer/bid pair.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a marketplace server for facilitating purchase transactions between merchants associated with merchant devices and users associated with user devices.

FIG. 2 is a diagram illustrating a method for facilitating purchase transactions showing communications among a marketplace server, two offer agents and two bid agents.

FIG. 3 is a continuation of the diagram of FIG. 2.

FIG. 4 is a continuation of the diagram of FIG. 3.

FIG. 5 is a continuation of the diagram of FIG. 4.

FIG. 6 is a continuation of the diagram of FIG. 5.

### DETAILED DESCRIPTION

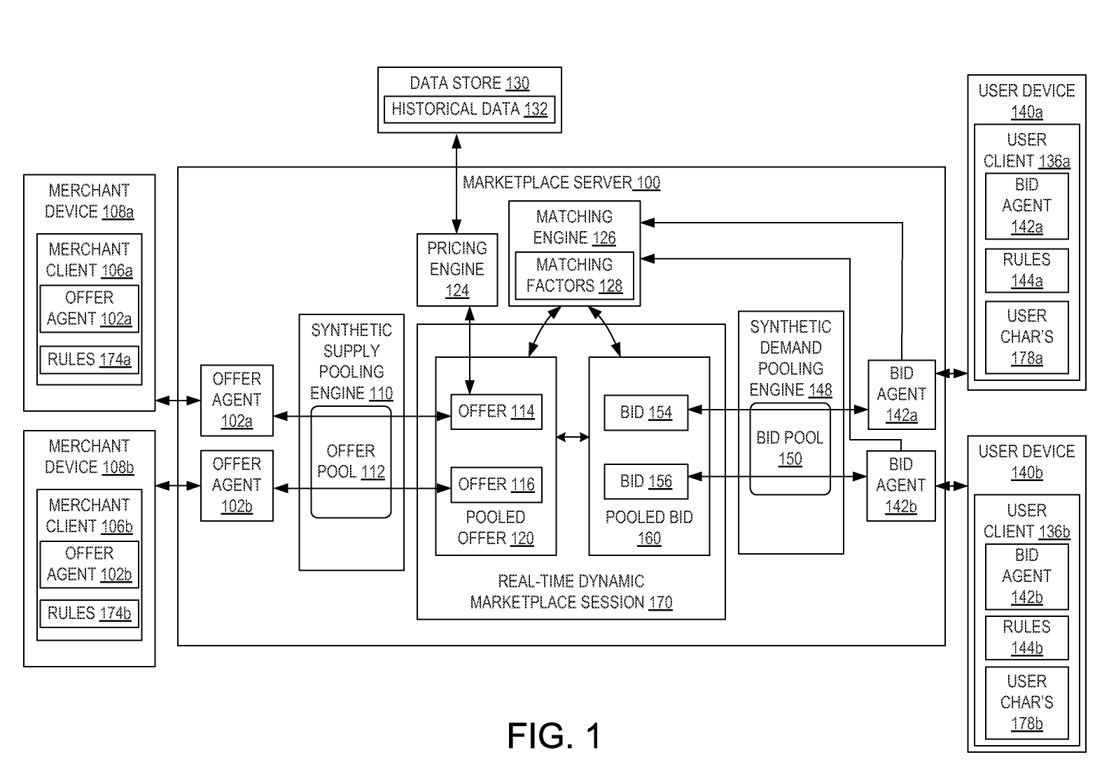

FIG. 1 is a schematic view of a marketplace server 100 for facilitating purchase transactions between merchants associated with merchant devices 108a/108b, and users associated with user devices 140a/140b. Each merchant device 108a/108b is associated with a respective merchant (not shown) that desires to sell goods and/or services to customers through the marketplace server 100. Each user device 140a/140b is associated with a respective user (not shown) that desires to purchase goods and/or services through the marketplace server 100.

Each merchant device 108a/108b includes a merchant client 106a/106b executed on the device that facilitates interactions between the merchant device and the marketplace server 100. Each merchant device 108a/108b is also associated with an offer agent 102a/102b. As described in more detail below, the offer agents 102a/102b may function as proxies for their respective merchants in conducting negotiations through the marketplace server 100. As shown in FIG. 1, the offer agents 102a/102b may be located on the marketplace server 100 or on their respective merchant clients 106a/106b. In the following example, the offer agents 102a/102b will be described as located on the marketplace server 100. Additionally, while FIG. 1 shows two merchant devices 108a and 108b corresponding to two merchants, in other examples additional merchants and corresponding merchant devices and offer agents may submit offers for goods and/or services and conduct negotiations through the marketplace server 100.

Each of the offer agents 102a/102b receives input from its corresponding merchant regarding the goods and/or services that the merchant desires to sell, along with rules for creating offers and conducting negotiations through the marketplace server 100. Using this input, each of the offer agents 102a/102b is configured to create and send one or more offers for goods/services to a synthetic supply pooling engine 110. The synthetic supply pooling engine 110 is configured to receive the offers from the offer agents 102a/102b and to gather the offers into an offer pool 112. In addition to the offers from offer agents 102a/102b, it will be appreciated that other offers from other offer agents may also be gathered in offer pool 112.

The synthetic supply pooling engine 110 then pools a first offer 114 from offer agent 102a and a second offer 116 from offer agent 102b to form a pooled offer 120. Criteria that the synthetic supply pooling engine 110 may use in pooling the offers may include, but are not limited to, type of goods/services, offer location, timing, consumer demand, etc. In one example, the first offer 114 may be for two tickets to Museum A in City B, and the second offer 116 may for a prix fixe dinner for two at Restaurant C near Museum A in the City B. The synthetic supply pooling engine 110 may identify the complimentary nature of the first offer 114 and second offer 116, and may pool these two offers into the pooled offer 120.

Offers 114 and 116 may include a price determined by the respective offer agents 102a and 102b. In another example, a pricing engine 124 may generate an initial price and/or a modified price for one or both of the offers 114 and 116. In generating an initial or modified price, the pricing engine 124 may perform predictive price modeling based on estimations of consumer demand for the goods/services of the relevant offer. In one example, the pricing engine 124 may access a data store 130 to retrieve historical transaction data 132 related to the goods/services of the relevant offer. The historical transaction data 132 may include data related to previous transactions for the same or similar goods/services. Such data may include, for example, recent prices paid by consumers for the same or similar goods/services. The pricing engine 124 may then use the historical transaction data 132 in performing predictive price modeling and generating an initial or modified price for the relevant offer.

With continued reference to FIG. 1, as noted above each user device 140a/140b is associated with a respective user (not shown) who desires to receive and bid on offers for goods and/or services through the marketplace server 100. Each user device 140a/140b includes a user client 136a/136b executed on the device that facilitates interactions between the user device and the marketplace server 100. Each user device 140a/140b is also associated with a bid agent 142a/142b. As described in more detail below, the bid agents 142a/142b may function as proxies for their respective users in conducting negotiations through the marketplace server 100. Like the offer agents 102a/102b described above, the bid agents 142a/142b may be located on the marketplace server 100 or on their respective user clients 136a/136b. In the following example, the bid agents 142a/142b will be described as located on the marketplace server 100. Additionally, while FIG. 1 shows two user devices 140a and 140b corresponding to two users, in other examples additional users and corresponding user devices and bid agents may submit bids for goods and/or services and conduct negotiations through the marketplace server 100.

Each of the bid agents 142a/142b receives input from its corresponding user regarding the types of offers for goods and/or services that the user desires to receive. Using this input, each of the bid agents 142a/142b is configured to send offer requests to a matching engine 126. The matching engine 126 is configured to match one or more pooled offers, such as pooled offer 120, to the offer requests received from the bid agents 142a/142b. In one example, the matching engine 126 is configured to match one or more pooled offers to the offer requests by matching one or more matching factors 128 received from offer agent 102a and/or offer agent 102b with a corresponding user characteristic received from bid agent 142a and/or bid agent 142b. The matching factors and corresponding user characteristics may include, for example, a type of the goods/services that was previously purchased by a user of the user device 140a/140b associated with one of the bid agents 142a/142b, a loyalty frequency reflecting a number of previous purchases made by the user from one of the merchants associated with the pooled offer 120, prices paid for the type of goods/services previously purchased, a location of the associated user device 140a/140b when the type of goods/services was previously purchased by the user, and a current location of the associated user device 140a/140b with respect to a location of the goods/services associated with the pooled offer 120. It will be appreciated that other matching factors and corresponding user characteristics may also be used by the matching engine 126.

In another example, the matching engine 126 is configured to match one or more pooled offers to the offer requests by identifying a social connection between the users of the user devices corresponding to the offer requests, and at least one preference shared by the users of the corresponding user devices. The matching engine 126 may identify a social connection, for example, by receiving the social graph of each user from the user's corresponding bid agent, such as bid agent 142a/142b, and locating each user on the social graph of one or more other users. Similarly, the matching engine 126 may identify a shared preference, for example, by examining social networking information, calendar data, location data, and/or other information provided the bid agents corresponding to the users, for preferences shared by the users. Preferences may include, for example, product, service, activity, hobby, entertainment, and fashion preferences.

Upon matching one or more pooled offers to the offer requests, the matching engine 126 is also configured to send the one or more matched pooled offers, such as pooled offer 120, to the bid agents 142a/142b. The bid agents 1142a/142b provide the matched pooled offers to their respective user devices 140a/140b via user clients 136a/136b for viewing by the corresponding users.

Upon viewing the pooled offers, the users may elect to bid on one of the offers. In one example, the bid agents 142a/142b may be configured to receive direct user input regarding selected offers and bidding parameters via the user devices 140a/140b. In another example, the bid agents 142a/142b may act as proxies for their corresponding users and proceed with selecting and negotiating for matched pooled offers on behalf of their users. In this example, the bid agents 142a/142b may be configured to programmatically select one or more offers on which to bid, and to generate the corresponding bid parameters for the offer(s). In this example, the bid agents 142a/142b may utilize one or more rules 144a/144b received from their associated user clients 136a/136b to select the offers and to generate the bid parameters. The rules 144a/144b may include, for example, user preferences for particular goods/services, bid pricing guidelines such as bid ceilings, etc.

Once a bid for an offer has been created, the bid agents 142a/142b may send the bid to a synthetic demand pooling engine 148. The synthetic demand pooling engine 148 is configured to receive bids from the bid agents 142a/142b and to gather the bids into a bid pool 150. The bids from bid agents 142a/142b may be for the same offer or for different offers. In addition to the bids from bid agents 142a/142b, it will be appreciated that additional bids from other bid agents may be gathered in bid pool 150.

In one example, a first bid 154 for pooled offer 120 is received by the synthetic demand pooling engine 148 from the bid agent 142a. A second bid 156 for pooled offer 120 from the bid agent 142b is also received by the synthetic demand pooling engine 148. As both the first bid 154 and the second bid 156 are for pooled offer 120, the synthetic demand pooling engine 148 pools the first bid 154 with the second bid 156 to form a pooled bid 160. In other examples the synthetic demand pooling engine 148 may utilize other criteria and/or characteristics of the bids in the bid pool 150 to determine which bids to pool together. Together, the pooled offer 120 and pooled bid 160 may be described as forming a pooled offer/bid pair.

The methods for pooling and matching offers, offer requests and bids discussed above may also employ data-centric methods, wherein offer configuration data regarding successful and unsuccessful configurations of offers is collected and leveraged as training and testing data. Such offer configuration data may include, but is not limited to, the types and timing of offers, detailed properties of the offers, and the actions and links among people, including graphical relationships in a social graph.

The offer configuration data may be used along with one or more machine learning procedures to build predictive models that can guide the creation and communication of offers and pools of bids/users with which they are matched. Machine learning procedures may include, but are not limited to, Bayesian structure search, Support Vector Machines, Gaussian Processes, logistic regression, and extensions to relational variants that take into consideration constraints or patterns of relationship among entities or properties.

In one example, a predictive offer pooling model may be built using offer configuration data and a machine learning procedure. The predictive offer pooling model may then be used to pool offers to form a pooled offer. In another example, a predictive matching model may be built using offer configuration data and a machine learning procedure. The predictive matching model may then be used to match the pooled offer to offer requests. In still another example, a predictive bid pooling model may be built using offer configuration data and a machine learning procedure. The predictive bid pooling model may then be used to pool bids to form a pooled bid. Particular examples in which these and other predictive models may be used to guide the pooling and matching of offers and bids are described in more detail below.

The matching engine 126 is further configured to establish a real-time dynamic marketplace session 170 between the offer agents 102a/102b and the bid agents 142a/142b in which a negotiation is facilitated between the merchants associated with offer agents 102a/102b and the users associated with the bid agents 142a/142b. In one example, one or both of the offer agents 102a/102b are configured to programmatically modify their respective offers 114/116 based on one or more rules 174a/174b received from their respective merchant clients 106a/106b to create a modified offer. The rules 174a/174b may include, for example, parameters for adjusting aspects of the offer such as price, quantity, timing, etc.

In another example, one or both of the offer agents 102a/102b are configured to programmatically modify their respective offers 114/116 based on one or more user characteristics 178a/178b received from a corresponding user client 136a/136b. The user characteristics 178a/178b may include, for example, a type of the goods/services that was previously purchased by the user associated with one of the bid agents 142a/142b, a loyalty frequency reflecting a number of previous purchases made by the user from a merchant associated with the pooled offer 120, a price paid for the type of goods/services previously purchased, a location of the associated user device 140a/140b when the type of goods/services was previously purchased by the user, and a current location of the associated user device 140a/140b with respect to a location of the goods/services associated with the pooled offer 120. It will be appreciated that other user characteristics may also considered and used by the offer agents 102a/102b.

When one of the offers 114/116 is modified by an offer agent 102a/102b, the synthetic supply pooling engine 110 may be configured to form a modified pooled offer that includes the modified offer. The modified pooled offer may then be sent to the bid agents 142a/142b for consideration. Upon receiving a modified pooled offer, one or both of the bid agents 142a/142b may be configured to programmatically modify their respective bids 154/156 based on one or more of the rules 144a/144b received from their associated user clients 136a/136b. As noted above, the rules 144a/144b may include, for example, user preferences for particular goods/services, bid pricing guidelines such as bid ceilings, etc.

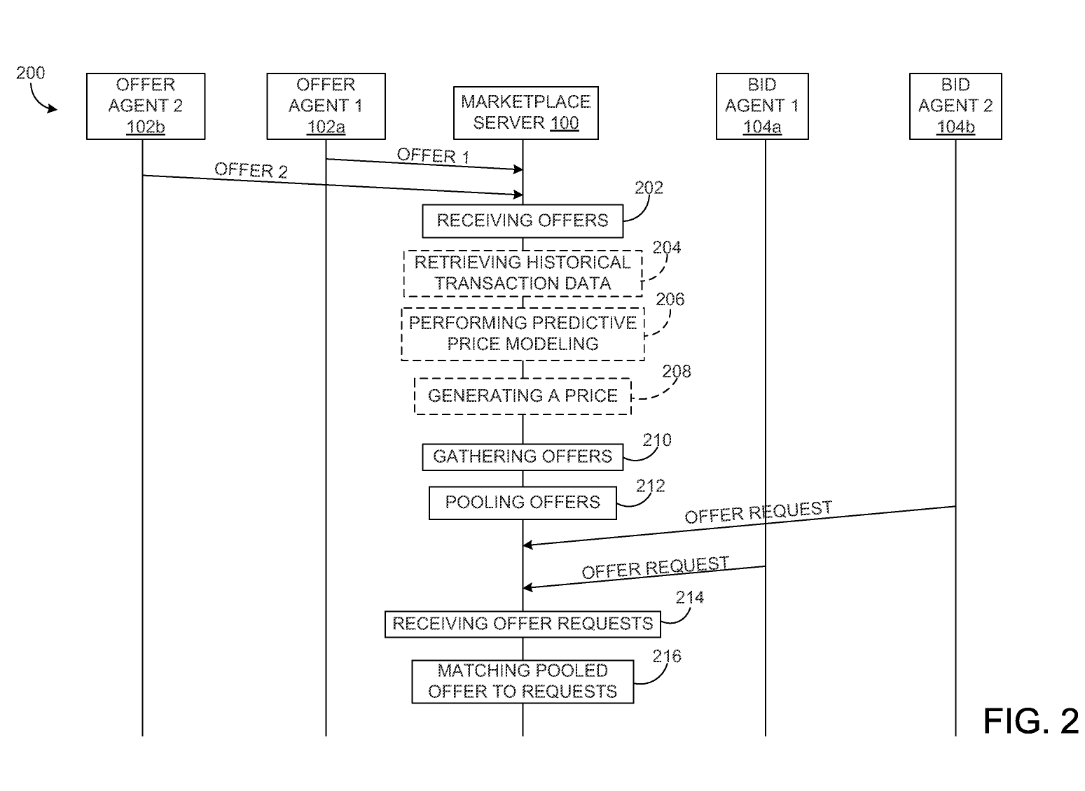

With reference now to FIG. 2, a diagram illustrates a method 200 for facilitating purchase transactions according to one embodiment of the present disclosure. The method 200 may be performed using the components of the marketplace server 100 described above and shown in FIG. 1, or using other suitable components. The method 200 begins at 202 with receiving an offer 1 from an offer agent 1, such as offer agent 102a, and an offer 2 from an offer agent 2, such as offer agent 102b. It will be appreciated that the method may also include receiving additional offers from other offer agents.

In one example, offer agent 1 is associated with Hotel A located in City B, and within walking distance of a baseball stadium where the Team A major league baseball club plays home games. Hotel A has 2 rooms available on Saturday June 30, with the standard rate for each of the rooms being $200 per night. Hotel A is willing to offer these rooms at a discount, and instructs offer agent 1 to create the offer 1 as follows—2 rooms available for Saturday June 30, $150 each.

Offer agent 2 is associated with the Team A major league baseball club, which has 4 tickets to its home game on Saturday June 30 that it would like to sell. The face value of the tickets is $75 each. Team A is willing to offer these tickets at a discount, and instructs offer agent 2 to create the offer 2 as follows—4 tickets available for the Team A home game against Team Z on Saturday June 30, $50 each.

In another example, offer 1 and/or offer 2 may be created without an initial price. In this example, at 204 the method may include retrieving historical transaction data from a data store, such as data store 130. At 206 the method may include performing predictive price modeling for offer 1 and/or offer 2 based on estimations of consumer demand for the goods/services of the relevant offer using the aggregated historical transaction data. The historical transaction data may include, for example, recent prices paid by consumers for the same or similar goods/services. At 208 the method may include generating an initial price for the offer 1 and/or offer 2 based on the predictive price modeling.

At 210 the method includes gathering offer 1, offer 2, and other offers from other offer agents (not shown) in an offer pool. At 212 the method includes pooling offer 1, offer 2 and perhaps other offers to form one or more pooled offers. As noted above, in one example offers may be pooled based on the complimentary nature of the goods/services that are offered. Other criteria that may be used in pooling offers may include, but are not limited to, offer location, timing, type of goods/services, consumer demand, etc. In the present example, the 2 rooms offered by Hotel A are for the same day (June 30) as the Team A home baseball game. Additionally, Hotel A is located within walking distance of the Team A stadium where the game will be played. Team A fans who live away from City B may be interested in a package offer containing tickets to the Team A game on June 30 along with a room at nearby Hotel A for that night. It follows that offer 1 from Hotel A and offer 2 from Team A may be pooled to form a pooled offer pair (offer 1/offer 2).

At 214 the method includes receiving offer requests from bid agent 1, such as bid agent 104a, and bid agent 2, such as bid agent 104b. Both bid agent 1 and bid agent 2 are associated with respective users who desire to receive offers from the marketplace server 100. In the present example, the offer requests from bid agent 1 and bid agent 2 both include requests to view offers for tickets to upcoming Team A home games.

At 216 the method includes matching one or more pooled offers to one or more requests for offers. In one example, matching pooled offers to requests for offers may include matching the type of goods/services offered in a pooled offer to the goods/services requested in a request for an offer. In another example, matching pooled offers to requests for offers may include matching one or more matching factors with a corresponding user characteristic of a user associated with one of a request for an offer. The matching factors and user characteristics may include, for example, a type of the goods/services that was previously purchased by a user, a loyalty frequency reflecting a number of previous purchases made by the user from a merchant associated with a pooled offer, a price paid for the type of goods/services previously purchased, a location of a user device associated with the user when the type of goods/services was previously purchased, and a current location of a user device associate with the user with respect to a location of the goods/services associated with a pooled offer. It will be appreciated that other matching factors and corresponding user characteristics may also be used.

In another example, matching pooled offers to requests for offers may include identifying a social connection between users of user devices corresponding to bid agents, and at least one preference shared by the users of the corresponding user devices. In one use case example, 4 friends who regularly play golf together are planning a vacation to Hawaii from August 1-7. Each friend makes an offer request, via her bid agent and corresponding user device, for 4-person Hawaiian vacation packages for August 1-7. The 4 friends are also connected through a social networking service, and each friend appears on the social graphs of the other 3 friends.

In matching pooled offers to these requests for Hawaiian vacation packages, the social connection among the users may be identified via social graph information provided by the corresponding bid agents. In another example, the friends may expressly identify their affiliation with each other in their offer requests. The friends affinity for playing golf together may also be identified by examining social networking information, calendar data, location data, and/or other information provided by the bid agents corresponding to the 4 friends. In this manner, a pooled offer for 4-person Hawaiian vacation packages that includes golf privileges may be matched to the friends' offer requests, potentially creating a more enjoyable vacation opportunity for the golfing friends.

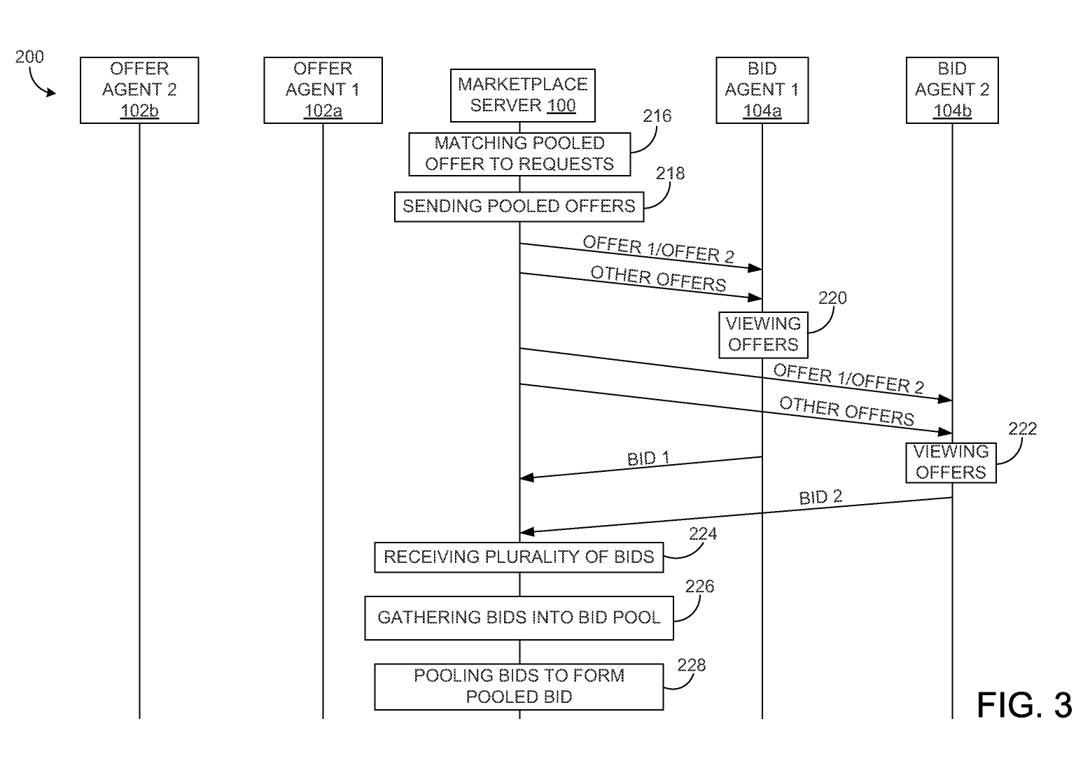

With reference now to FIG. 3, which is a continuation of FIG. 2, and returning to the example involving Team A and Hotel A, at 218 the method includes sending one or more pooled offers to bid agent 1 and bid agent 2. As both bid agents requested offers for tickets to upcoming Team A home games, the offer 1/offer 2 pooled offer is sent to both bid agent 1 and bid agent 2. Other pooled offers that may be of interest may also be sent to both bid agents. At 220 the user associated with bid agent 1 views the offers received, and at 222 the user associated with bid agent 2 views the offers received.

At 224 the method includes receiving a plurality of bids, including a bid 1 from bid agent 1 for the offer 1/offer 2 pooled offer, and a bid 2 from bid agent 2 for the offer 1/offer 2 pooled offer. In this example, bid 1 includes a bid of $70 for 2 of the Team A game tickets and $140 for one room in Hotel A on June 30. Bid 2 includes a bid of $85 for 2 of the Team A game tickets and $145 for one room in Hotel A on June 30. At 226 the method includes gathering the bids into a bid pool. At 228 the method includes pooling bid 1 with bid 2 to form a bid 1/bid 2 pooled bid. In one example, the method may pool bid 1 and bid 2 by determining that both bids are directed to the offer 1/offer 2 pooled offer. In other examples other criteria of the offers in the bid pool may be utilized to determine which offers to pool together. Together, the offer 1/offer 2 pooled offer and bid 1/bid 2 pooled bid may be described as forming a pooled offer/bid pair. In this example, the pooled offer/bid pair includes a total bid of $155 ($70+$85) for the 4 Team A tickets and $285 ($140+$145) for the 2 Hotel A rooms.

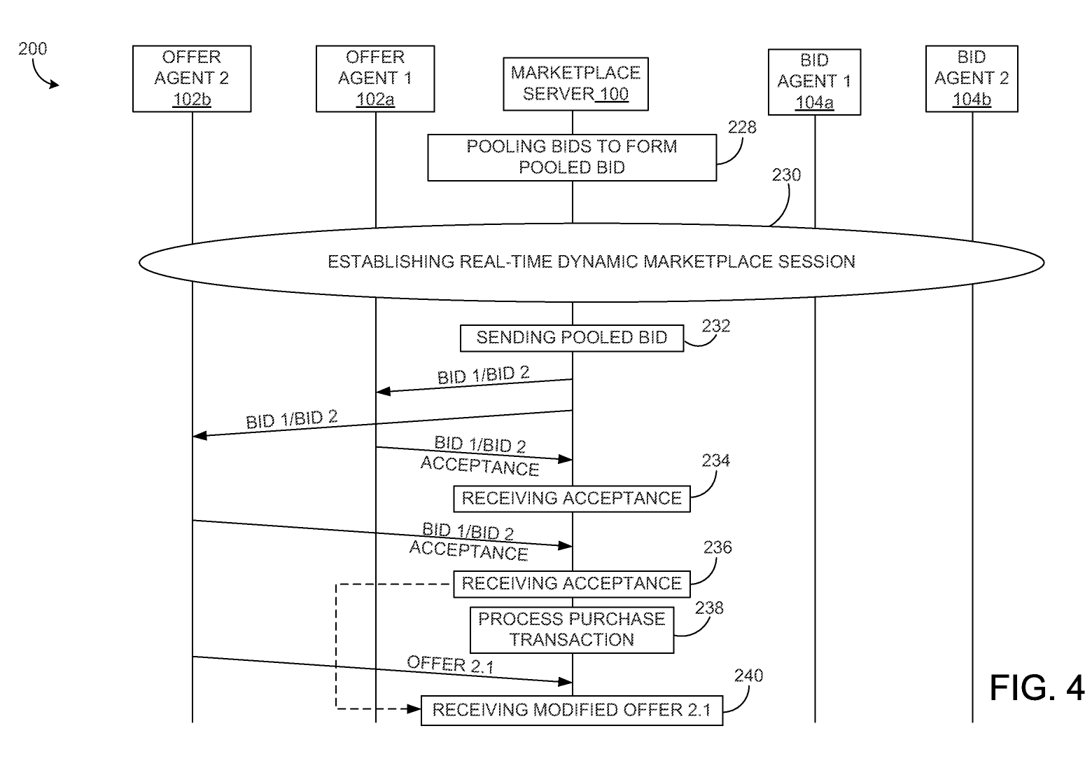

With reference now to FIG. 4, which is a continuation of FIG. 3, at 230 the method includes establishing a real-time dynamic marketplace session between office agents 1 and 2 and bid agents 1 and 2 in which a negotiation is facilitated between Team A/Hotel A and the users associated with bid agents 1 and 2. At 232 the method includes sending the bid 1/bid 2 pooled bid to offer agent 1 and offer agent 2. Offer agent 1 reviews the bid 1/bid 2 pooled bid, and in particular reviews the combined bid of $285 for the 2 Hotel A rooms (its portion of the pooled bid), to determine whether to accept, modify or reject its portion. Similarly, offer agent 2 reviews the bid 1/bid 2 pooled bid, and in particular the combined bid of $155 for the 4 Team A tickets (its portion of the pooled bid), to determine whether to accept, modify or reject its portion. In other examples, offer agents 1 and 2 may receive direct input from users associated with Hotel A and Team A, respectively, regarding whether to accept, modify or reject their portion of the pooled bid.

In the present example, at 234 the method includes receiving an acceptance from offer agent 1 (Hotel A) for its portion of the pooled bid. At 236 the method includes receiving an acceptance from offer agent 2 (Team A) for its portion of the pooled bid. With both portions of the pooled bid accepted, at 238 the method includes processing a purchase transaction for the 4 Team A tickets and 2 Hotel A rooms between Team A, Hotel A and the two bid agents 1 and 2.

In another example, although offer agent 1 (Hotel A) accepts its portion of the pooled bid, offer agent 2 does not accept its portion of the pooled bid. In this example, at 240 the method includes receiving a modified offer 2.1 from offer agent 2 that comprises a revision to the original offer 2 included in the offer 1/offer 2 pooled offer. For example, modified offer 2.1 may include a lower offer price of $45 per ticket, for a total of $180 for 4 tickets. As noted above, the modified offer 2.1 may be modified based on one or more rules received from merchant clients associated with offer agent 2. The rules may include, for example, parameters for adjusting aspects of the offer such as price, quantity, timing, etc. In another example, the modified offer 2.1 may be modified based on one or more user characteristics of users associated with bid agents 1 and 2. In this example the user characteristics may include, for example, a type of the goods/services that was previously purchased from Team A by a user associated with one of the bid agents 1 and 2, a loyalty frequency reflecting a number of previous purchases made by the user from Team A, a price paid for the type of goods/services previously purchased, and a location of the user. It will be appreciated that other user characteristics may also considered and used to create modified offer 2.1.

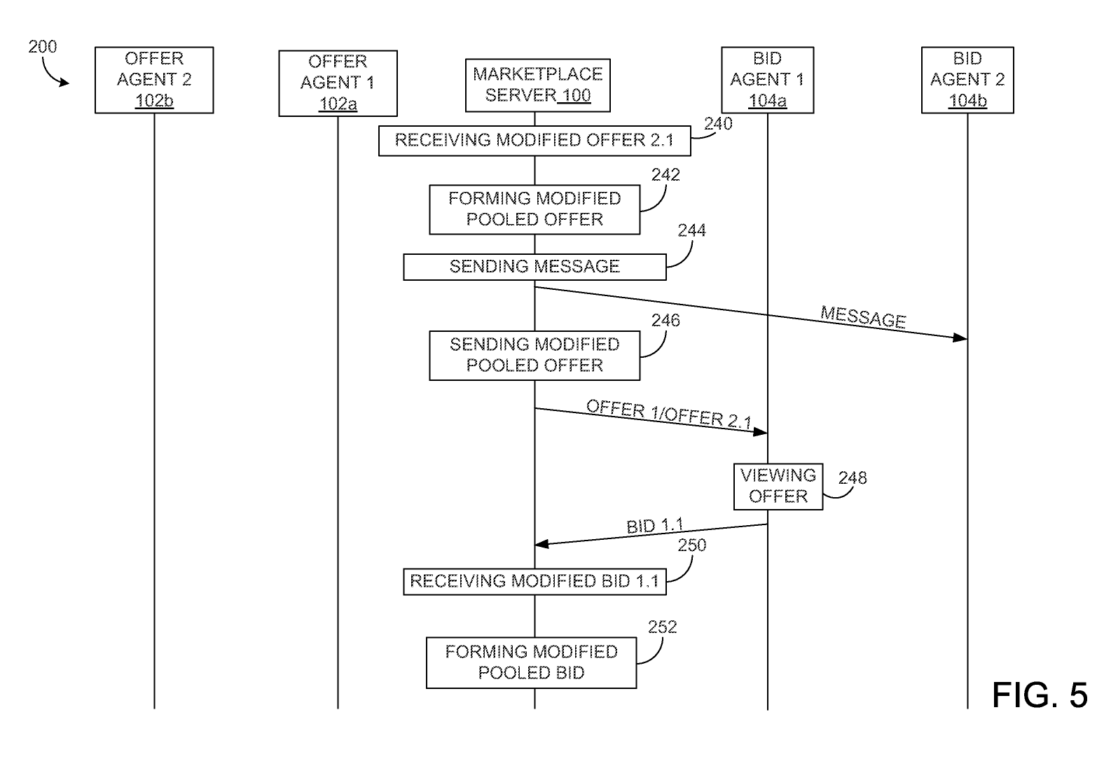

With reference now to FIG. 5, which is a continuation of FIG. 4, at 242 the method includes forming a modified pooled offer 1/offer 2.1 that includes the original offer 1 and the modified offer 2.1. In forming the modified pooled offer 1/offer 2.1, the method may allocate $85 (for 2 Team A tickets) of the modified offer 2.1 total price of $180 to bid agent 2, which matches the original bid 2 of $85 received from bid agent 2 (and leaves $95 of the modified offer 2.1 to be allocated to bid agent 1). Also, given that offer agent 1 (Hotel A) accepted the original bids for its portion of the original pooled offer 1/offer 2, the original bid 2 from bid agent 2 now matches the portions of modified offer 2.1 allocated to bid agent 2. Pending a successful negotiation with offer agent 1, the original bid 2 from bid agent 2 may be accepted. In this case, at 244 the method may include sending a status message to bid agent 2 indicating that its bid 2 is in process or otherwise still pending.

At 246 the method may include sending the modified pooled offer 1/offer 2.1 to bid agent 1. As noted above, $95 of the modified offer 2.1 total price of $180 is allocated to bid agent 1. At 248 the modified pooled offer 1/offer 2.1 is viewed by the user associated with bid agent 1. In this example, given that offer agent 1 (Hotel A) previously accepted the original bids for its portion of the original pooled offer 1/offer 2, the original offer 1 bid of $140 for 1 Hotel A room is shown as “accepted” to the user. Bid agent 1 may then compare its original bid of $70 for 2 Team A tickets (i.e., $35 per ticket) to the modified offer 2.1 of $95 for 2 tickets (i.e., $47.50 per ticket). In this example, bid agent 1 creates a modified bid 1.1 that includes an increased bid of $80 for the 2 tickets (i.e., $40 per ticket). At 250 the method includes receiving the modified bid 1.1 of $80 for the 2 tickets.

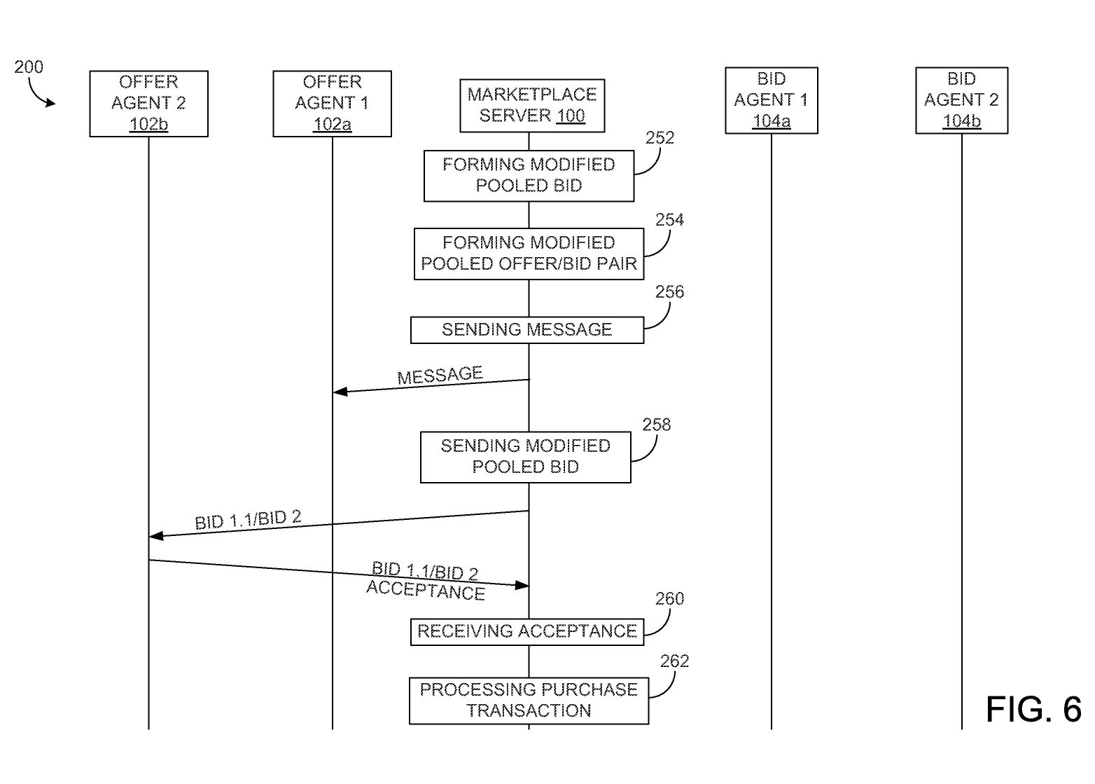

At 252 the method includes forming a modified pooled bid that includes modified bid 1.1. With reference now to FIG. 6, which is a continuation of FIG. 5, at 254 the method includes forming a modified pooled offer/bid pair. At 256 the method may include sending a status message to offer agent 1, which previously accepted its portion of the original pooled offer/bid pair, indicating that the negotiation is still pending. At 258 the method includes sending the modified pooled bid including modified bid 1.1/bid 2 to offer agent 2 for consideration. In the present example, offer agent 2 accepts the modified pooled bid including modified bid 1.1. At 260 the method includes receiving an acceptance from offer agent 2. At 262, with both portions of the modified pooled offer/bid pair accepted, the method includes processing a purchase transaction for the 4 Team A tickets and 2 Hotel A rooms between Team A, Hotel A and the two bid agents 1 and 2.

According to another aspect of the present invention, a method for facilitating purchase transactions may include receiving at least one offer for goods/services, with the offer being based on merchant input received at a first offer agent. The method may include receiving a package offer request from a bid agent, with the package offer request including at least two offer components. In one example, the package offer request may include a request for a Hawaiian vacation that includes airfare, hotel accommodations, and golfing privileges. The at least one offer for goods/services may include airfare and hotel accommodations, but may not include a golfing privileges component.

The method may further include soliciting a supplemental offer from a second offer agent. In the above example, the supplemental offer may include golfing privileges at a golf course near the hotel of the at least one offer. The method includes receiving the supplemental offer from the second offer agent, and pooling the supplemental offer and the at least one offer to form a pooled offer. The method further includes matching the pooled offer to the package offer request, and sending the pooled offer to the bid agent.

The method further includes receiving a bid from the bid agent, with the pooled offer and the bid forming a pooled offer/bid pair. The method also includes establishing a real-time dynamic marketplace session between the first offer agent and the second offer agent, and the bid agent. The method further includes sending the bid to the first offer agent and the second offer agent, and receiving acceptances of the bid from the first and the second offer agents. The method further includes processing a purchase transaction for the pooled offer/bid pair.

The above described systems and methods may be used to address the marketplace inefficiencies discussed in the Background which are created by the lack of communication tools between sellers, between buyers, and between buyers and sellers in the online marketplace experience, thereby improving the chances that willing buyers and willing sellers will consummate at an agreed upon transaction.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A marketplace server, comprising:
a synthetic supply pooling engine configured to receive a plurality of offers for goods/services, each of the offers being based on merchant input received at an offer agent located on the marketplace server or on a merchant client executed on a respective merchant device, the offers being gathered in an offer pool, the synthetic supply pooling engine also configured to pool at least two of the offers from selected merchants to form a pooled offer; and
a matching engine configured to:
match the pooled offer to at least two offer requests received from respective bid agents located on the marketplace server or on user clients executed on corresponding user devices;
send the pooled offer to the bid agents;
receive a pooled bid including at least two bids from the bid agents, the pooled offer and the pooled bid forming a pooled offer/bid pair;
establish a real-time dynamic marketplace session between the offer agents and the bid agents in which a negotiation is facilitated between the selected merchants and users of the corresponding user devices; and
upon receiving acceptances of the pooled bid from the offer agents, process a purchase transaction for the pooled offer/bid pair.

2. The marketplace server of claim 1, further comprising a synthetic demand pooling engine configured to:
receive a plurality of bids including the at least two bids from the bid agents;
gather the plurality of bids in a bid pool; and
pool the at least two bids to form the pooled bid.

3. The marketplace server of claim 1, wherein at least one of the offer agents associated with the selected merchants is configured to programmatically modify the offer from its respective merchant, based on one or more rules received from its associated merchant client, to create a modified offer.

4. The marketplace server of claim 3, wherein the at least one offer agent is also configured to programmatically modify the offer from its respective merchant based on one or more user characteristics received from one of the bid agents.

5. The marketplace server of claim 4, wherein the synthetic supply pooling engine is configured to form a modified pooled offer including the modified offer, with the modified pooled offer being sent to each of the bid agents.

6. The marketplace server of claim 1, wherein at least one of the bid agents is configured to programmatically modify the bid from its respective user, based on one or more rules received from its associated user client, to create a modified bid.

7. The marketplace server of claim 1, wherein the matching engine is further configured to match the pooled offer to the at least two offer requests by identifying a social connection between the users of the corresponding user devices, and at least one preference shared by the users of the corresponding user devices.

8. The marketplace server of claim 1, further comprising a pricing engine configured to generate an initial price and/or a modified price for one of the at least two offers.

9. The marketplace server of claim 8, wherein the pricing engine is further configured to:
retrieve aggregated historical transaction data from a data store;
perform predictive price modeling based on the aggregated historical transaction data for at least one of the at least two offers; and
generate the initial price and/or the modified price based on the predictive price modeling.

10. A method for facilitating purchase transactions, the method comprising:
receiving a plurality of offers for goods/services, each of the offers being based on merchant input received at an offer agent;
gathering the plurality of offers in an offer pool;
pooling at least two of the offers to form a pooled offer;
receiving at least two offer requests from respective bid agents;
matching the pooled offer to the at least two offer requests;
sending the pooled offer to the bid agents;
pooling at least two bids received from the bid agents to form a pooled bid, the pooled offer and the pooled bid forming a pooled offer/bid pair;
establishing a real-time dynamic marketplace session between the offer agents associated with the at least two offers and the bid agents;
sending the pooled bid to the offer agents;
receiving acceptances of the pooled bid from the offer agents; and
processing a purchase transaction for the pooled offer/bid pair.

11. The method of claim 10, further comprising:
building a predictive offer pooling model using offer configuration data and a machine learning procedure; and
wherein the pooling at least two of the offers to form the pooled offer further comprises using the predictive offer pooling model to form the pooled offer.

12. The method of claim 11, further comprising:
building a predictive matching model using the offer configuration data and the machine learning procedure; and
wherein the matching the pooled offer to the at least two offer requests further comprises using the predictive matching model to match the pooled offer to the at least two offer requests.

13. The method of claim 12, further comprising:
building a predictive bid pooling model using the offer configuration data and the machine learning procedure; and
wherein the pooling at least two bids received from the bid agents to form the pooled bid further comprises using the predictive bid pooling model to form the pooled bid.

14. The method of claim 10, further comprising receiving a modified offer including a revision to one of the at least two offers based on one or more rules received from a merchant client and/or one or more user characteristics received from one of the bid agents.

15. The method of claim 14, further comprising:
forming a modified pooled offer including the modified offer; and
sending the modified pooled offer to the bid agents.

16. The method of claim 10, further comprising receiving a modified bid including a revision to one of the at least two bids based on one or more rules received from a user client.

17. The method of claim 16, further comprising:
forming a modified pooled bid including the modified bid; and
sending the modified pooled bid to the offer agents.

18. The method of claim 10, wherein the matching the pooled offer to the at least two offer requests further comprises matching one or more matching factors with a corresponding user characteristic received from one of the bid agents.

19. The method of claim 10, further comprising:
retrieving aggregated historical transaction data from a data store;
performing predictive price modeling based on the aggregated historical transaction data for at least one of the plurality of offers; and
generating an initial price and/or a modified price for the at least one of the plurality of offers based on the predictive price modeling.

20. A method for facilitating purchase transactions, the method comprising:
receiving at least one offer for goods/services, the offer being based on merchant input received at a first offer agent;
receiving a package offer request from a bid agent, the package offer request including at least two offer components;
soliciting a supplemental offer from a second offer agent, the supplemental offer including one of the at least two offer components;
receiving the supplemental offer from the second offer agent;
pooling the supplemental offer and the at least one offer to form a pooled offer;
matching the pooled offer to the package offer request;
sending the pooled offer to the bid agent;
receiving a bid from the bid agent, the pooled offer and the bid forming a pooled offer/bid pair;
establishing a real-time dynamic marketplace session between the first offer agent and the second offer agent, and the bid agent;
sending the bid to the first offer agent and the second offer agent;
receiving acceptances of the bid from the first offer agent and the second offer agent; and
processing a purchase transaction for the pooled offer/bid pair.
